(19) United States
(12) Patent Application Publication
(10) Pub. No.: US 2005/0233100 A1
(43) Pub. Date: Oct. 20, 2005

(54) Continuously spiraled, high porosity plastic material structure

(76) Inventor: Ping-Jung Chang, Changhua City (TW)

Correspondence Address: RABIN & BERDO, P.C.;Suite 500, 1101 14th Street, N.W., Washington, DC, 20005, US

(21) Appl. No.: 10/959,211

(22) Filed: Oct. 7, 2004

(30) Foreign Application Priority Data
Mar. 26, 2004 (TW) 93204599

(51) Int. Cl. B32B 3/26; D04H 3/02

(52) U.S. Cl. 428/37; 428/304.4; 428/71

(57) ABSTRACT

A continuously spiraled, high porosity plastic material structure consisting of a soft, resilient plastic material, thin strands of plastic filament having hardness and strength. After the long, thin plastic filament is entwined and rolled in a continuous spiral utilizing an up and down vertically spiraled approach into a predetermined, three dimensional, and high porosity plastic material entity, the plastic filament changes direction from an up and down vertically spiraled approach to a left and right horizontal approach. Both the top and bottom surfaces of the original, predetermined, three-dimensional, and high porosity plastic material entity are then entwined and rolled in a continuous spiral such that the original plastic material entity becomes a level plane and thereby vertically and horizontally interlaced into a plastic material entity. Furthermore, the plastic material entity is manufactured by a single production process and fabrication step, and can be utilized and freely interchanged among them.

### BACKGROUND OF THE INVENTION

1) Field of the Invention

The invention herein relates to a continuously spiraled, high porosity plastic material structure in which after plastic filament is entwined and rolled in a continuous spiral utilizing an up and down vertically spiraled approach into a predetermined, three dimensional, and high porosity plastic material entity, the plastic filament changes direction from an up and down vertically spiraled approach to a left and right horizontal approach, and both the top and bottom surfaces of the original, predetermined, three-dimensional, and high porosity plastic material entity are then entwined and rolled in a continuous spiral such that the original plastic material entity becomes a level plane and thereby vertically and horizontally interlaced into a plastic material entity.

2) Description of the Prior Art

Conventionally utilized plastic material structures are typically formed according to various three-dimensional spatial arrangements (such as a solid, planar, non-standard, and other combined forms) and, furthermore, according to the specific application and the fabrication material required. The plastic material entities fabricated for various applications are not interchangeable and universally usable. As such, plastic material entities require different production processing and fabrication for each different application, which is wasteful and not conducive to economic benefit

### SUMMARY OF THE INVENTION

In view of the shortcomings of the said prior art structures, the applicant of the invention herein having many years experience in the related technology successfully developed several innovative improvements that are demonstrably workable and capable of additional functionality, which are now submitted in application for patent rights.

The primary objective of the invention herein is to provide a continuously spiraled, high porosity plastic material structure consisting of a soft, resilient plastic material that is heat melted and vertically flowed as continuous spirals utilizing a perforated mold and then tempered and cooled at low speed into shape to eliminate internal crystalline stress and thereby form long, thin strands of plastic filament having hardness and strength. After the long, thin plastic filament is entwined and rolled in a continuous spiral utilizing an up and down vertically spiraled approach into a predetermined, three dimensional, and high porosity plastic material entity, the plastic filament changes direction from an up and down vertically spiraled approach to a left and right horizontal approach. Both the top and bottom surfaces of the original predetermined, three-dimensional, and high porosity plastic material entity are then entwined and rolled in a continuous spiral such that the original plastic material entity becomes a level plane and thereby vertically and horizontally interlaced into a plastic material entity. Furthermore, the plastic material entity of the invention herein is manufactured by a single production process and fabrication step, and can be utilized in various applications and freely interchanged among them.

### BRIEF DESCRIPTION OF THE DRAWINGS

FIG. 1-A is an orthographic drawing of the invention herein (1).

FIG. 1-B is an orthographic drawing of the invention herein (2).

FIG. 1-C is an orthographic drawing of the invention herein (3).

FIG. 1-D is an orthographic drawing of the invention herein (4).

FIG. 1-E is an isometric drawing of the invention herein.

FIG. 2-A is an isometric drawing of the invention herein during production processing.

FIG. 2-B is an orthographic drawing of the invention herein after production processing.

FIG. 3-A is an isometric drawing of an embodiment of the invention herein (1).

FIG. 3-B is an orthographic drawing of an embodiment of the invention herein (1).

FIG. 4-A is an isometric drawing of an embodiment of the invention herein (2).

FIG. 4-B is an orthographic drawing of an embodiment of the invention herein (2).

FIG. 4-C is an orthographic drawing of an embodiment of the invention herein (2).

FIG. 4-D is an isometric drawing of an embodiment of the invention herein (2).

FIG. 5-A is an isometric drawing of an embodiment of the invention herein (3).

FIG. 5-B is a cross-sectional drawing of an embodiment of the invention herein (3).

FIG. 5-C is an isometric drawing of an embodiment of the invention herein (3).

FIG. 5-D is a cross-sectional drawing of an embodiment of the invention herein (3).

FIG. 5-E is a cross-sectional drawing of an embodiment of the invention herein (3).

FIG. 6-A is an isometric drawing of an embodiment of the invention herein (4).

FIG. 6-B is an isometric drawing of an embodiment of the invention herein (4).

FIG. 6-C is a cross-sectional drawing of an embodiment of the invention herein (4).

FIG. 6-D is a cross-sectional drawing of an embodiment of the invention herein (4).

FIG. 6-E is a cross-sectional drawing of an embodiment of the invention herein (4).

FIG. 7 is an orthographic drawing of an embodiment of the invention herein (5).

### DETAILED DESCRIPTION OF THE PREFERRED EMBODIMENTS

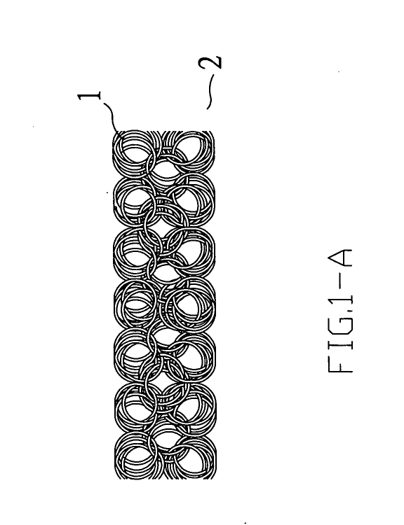

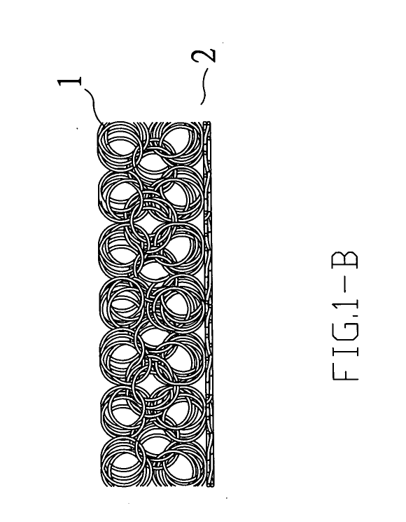

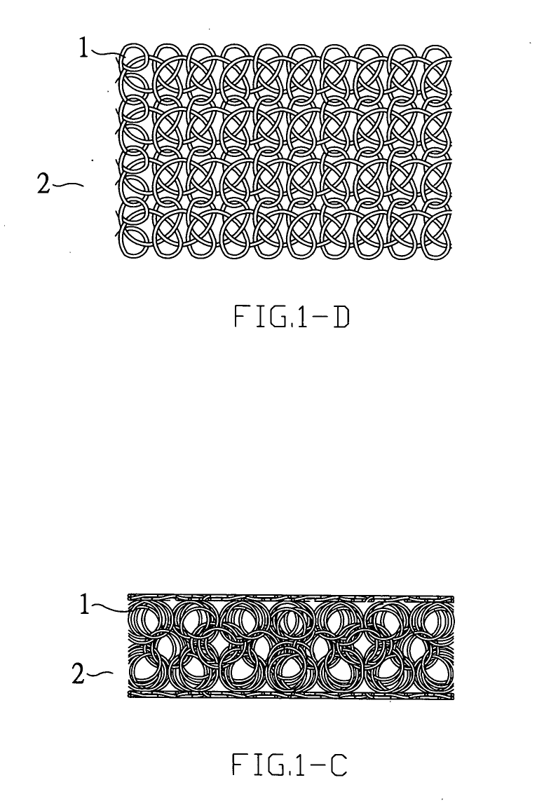

Referring to FIG. 1-A, FIG. 1-B, FIG. 1-C, FIG. 1-D, and FIG. 1-E, the continuously spiraled, high porosity plastic material structure of the invention herein is a soft, resilient plastic material that is heat melted and vertically flowed as continuous spirals utilizing a perforated mold and then tempered and cooled at low speed into shape to eliminate internal crystalline stress and thereby form long, thin strands of plastic filament 1 having hardness and strength, and after the long, thin plastic filament 1 is entwined and rolled in a continuous spiral utilizing an up and down vertically spiraled approach into a predetermined, high porosity, and three dimensionally shaped plastic material entity 2 (as shown in FIG. 1-A, the external appearance is similar to the cellular foam of the prior art and can be a planar or cylindrical material with compound plastic pliancy and resiliency), the plastic filament 1 changes direction from an up and down vertically spiraled approach to a left and right horizontal approach, and both the top and bottom surfaces of the original predetermined three-dimensionally shaped plastic material entity 2 are entwined and rolled in a continuous spiral such that the original, predetermined, and three-dimensionally shaped plastic material entity 2 becomes a level plane and thereby vertically and horizontally interlaced into a predetermined, three-dimensionally shaped plastic material entity 2 (as shown in FIG. 1-B and FIG. 1-C).

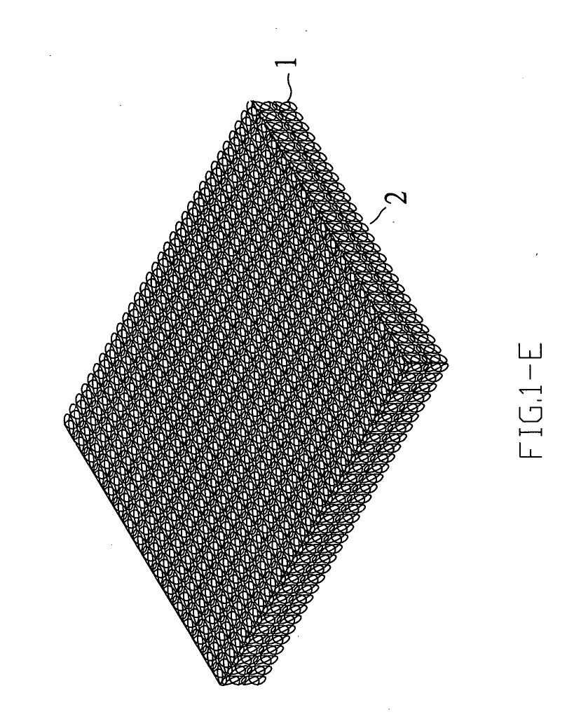

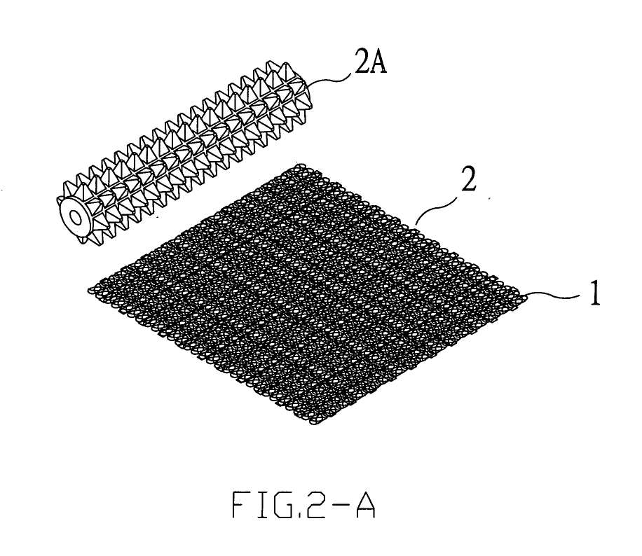

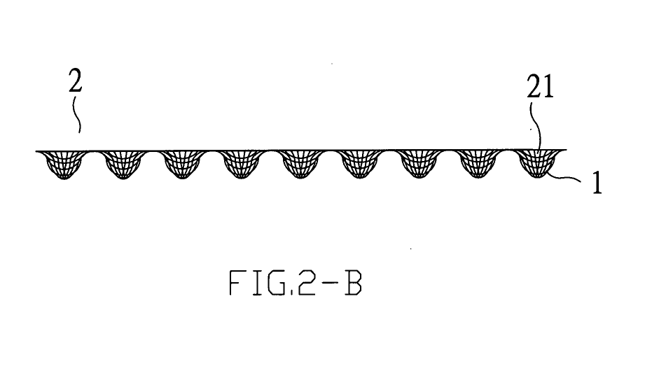

Referring to FIG. 2-A and FIG. 2-B, after the long, thin plastic filament 1 is entwined and rolled in a continuous spiral utilizing an up and down vertically spiraled approach into the predetermined high porosity, three-dimensionally shaped plastic material entity 2 of the invention herein, a mold pressure forms wave-like corrugations on the surface of the predetermined high porosity, three-dimensionally shaped plastic material entity 2, wherein after the long, thin plastic filament 1 is entwined and rolled in a continuous spiral utilizing an up and down vertically spiraled approach into a predetermined high porosity, three-dimensional shape, the plastic filament 1 changes direction from an up and down vertically spiraled approach to a left and right horizontal approach, and at the original predetermined, three-dimensionally shape, both the top and bottom surfaces are entwined and rolled in a continuous spiral such that the original, predetermined, and three-dimensional shape is formed into a level plane and thereby horizontally and vertically interlaced into a predetermined, three-dimensional shape, and similarly a roller wheel mold 2A pressure forms wave-like corrugations 21 on the surface of the predetermined high porosity, three-dimensionally shaped plastic material entity 2.

Furthermore, the three-dimensional, high porosity plastic material entity 2 of the invention herein is comprised of a soft, resilient plastic material that is heat melted and vertically flowed as continuous spirals utilizing a perforated mold and then tempered and cooled at low speed into shape to form long, thin strands of plastic filament 1, and after the long, thin plastic filament 1 is entwined and rolled in a continuous spiral utilizing an up and down vertically spiraled approach into a predetermined, three-dimensional, and high porosity plastic material entity 2, the plastic filament 1 changes direction from an up and down vertically spiraled approach to a left and right horizontal approach, and both the top and bottom surfaces of the original predetermined, three-dimensional, and high porosity plastic material entity 2 are entwined and rolled in a continuous spiral such that the original plastic material entity 2 is formed into a level plane and thereby vertically and horizontally interlaced in the plastic material entity 2; furthermore, the plastic material entity 2 of the invention herein is manufactured by a single production process and fabrication step, and can be utilized in various applications and freely interchanged among them, with the structural features of the most preferred embodiments of the invention herein, as utilized in various applications and freely interchanged among them, elaborated below:

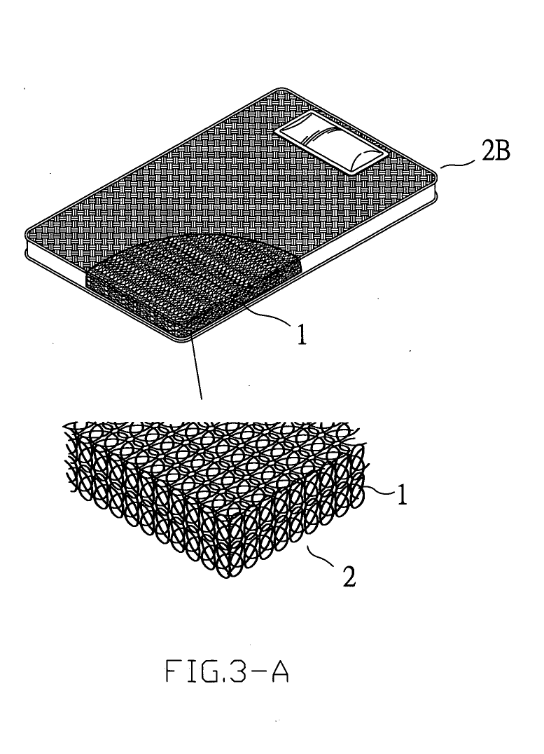

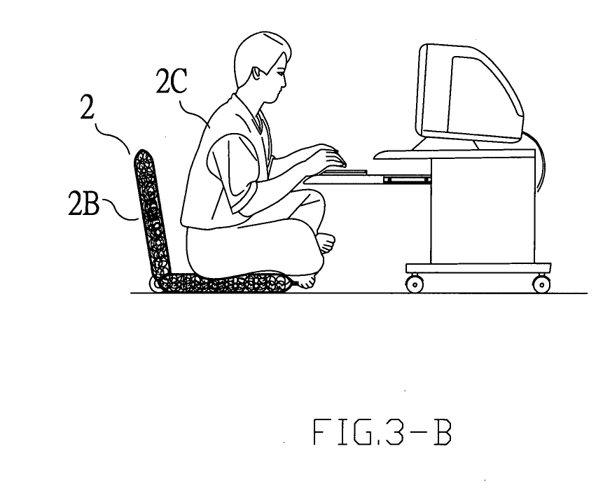

1. When the plastic material entity 2 of the invention herein has a soft structure, it can be fabricated as a couch, bed, or seat cushion base material (as shown in FIG. 3-A and FIG. 3-B) to replace commonly used cellular foam and coconut materials to improve damp heat and lack of ventilation characteristics, and also enhance infrared-resistant material into a healthier and cleaner ventilated material.

Additionally, since the plastic material entity 2 can be fabricated as a couch, bed, or seat cushion 2B base material, over periods of time during the utilization process, not only does nothing ever fall from the couch, bed, or seat cushion 2B, even after the couch, bed, or seat cushion 2B has been in long-term use, nothing ever drops out of the plastic material entity 2 filling the couch, bed, or seat cushion 2B, thereby preventing environmental untidiness and pollution as well as averting unnecessary problems and difficulties.

At the same time, since the plastic material entity 2 filling the couch, bed, or seat cushion 2B has unique characteristics such as zero heat accumulation, cool ventilation, elastic softness, all-season use capability, and deformity resistance such that periods of long-term couch, bed, and seat usage does not result in muggy, uncomfortable feelings, utilization does not result in harm to the human body 2C, and the health of the human body is maintained.

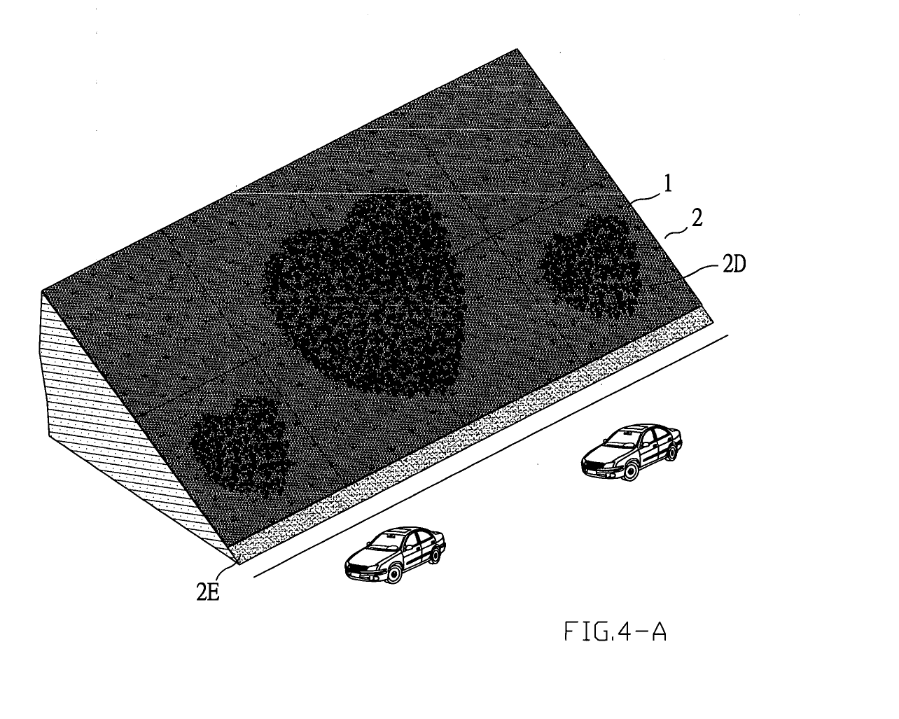

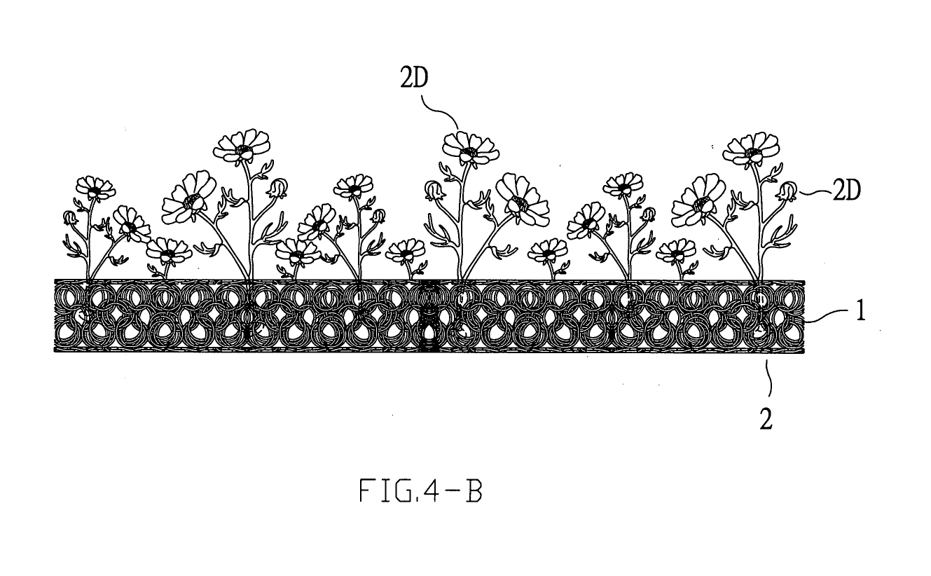

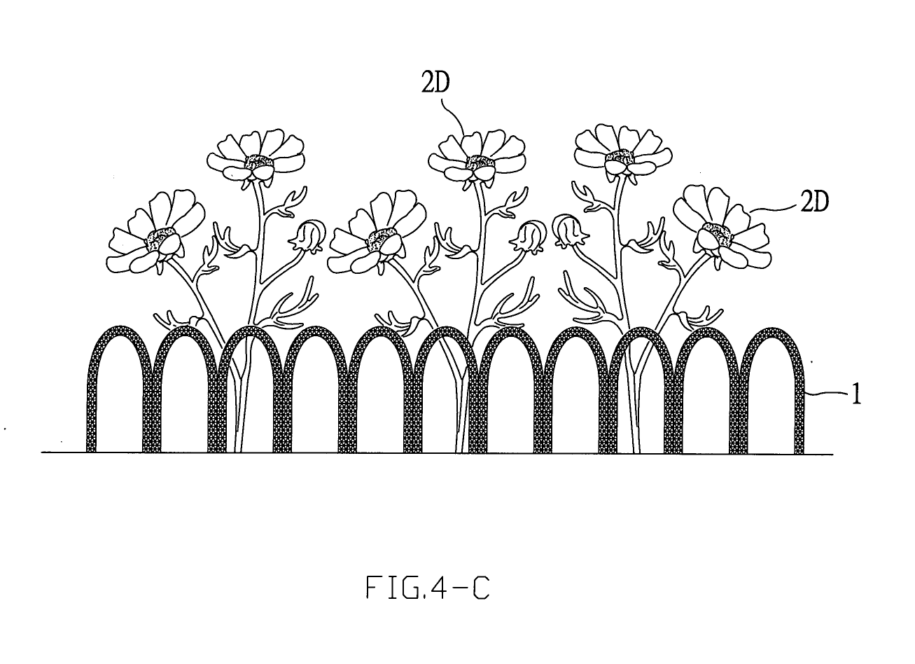

2. The plastic material entity 2 structure of the invention herein adheres to the ground and is capable of strengthening early plant growth, allowing accelerated flower and plant 2D root growth and better drainage, while also capable of decomposition and environmental protection applications, enabling soil decomposing and absorption in short periods for the accomplishment of environmentally protective reclamation, as indicated in FIG. 4-A, FIG. 4-B, FIG. 4-C, and FIG. 4-D.

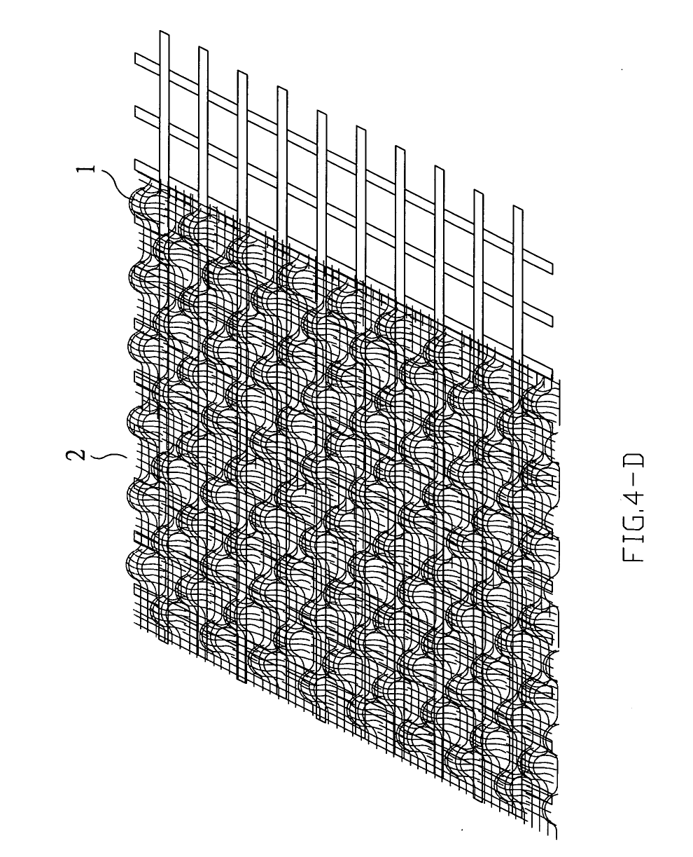

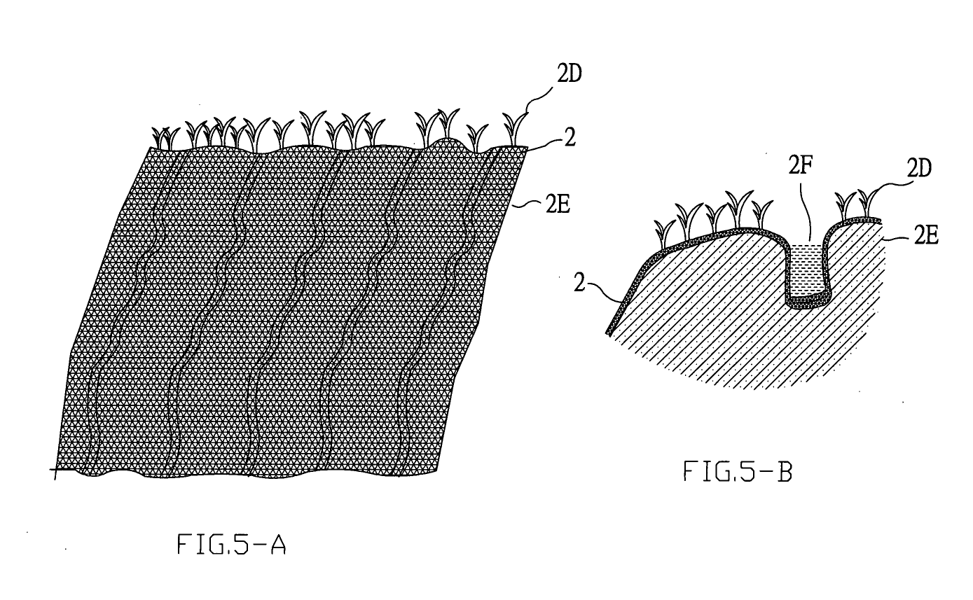

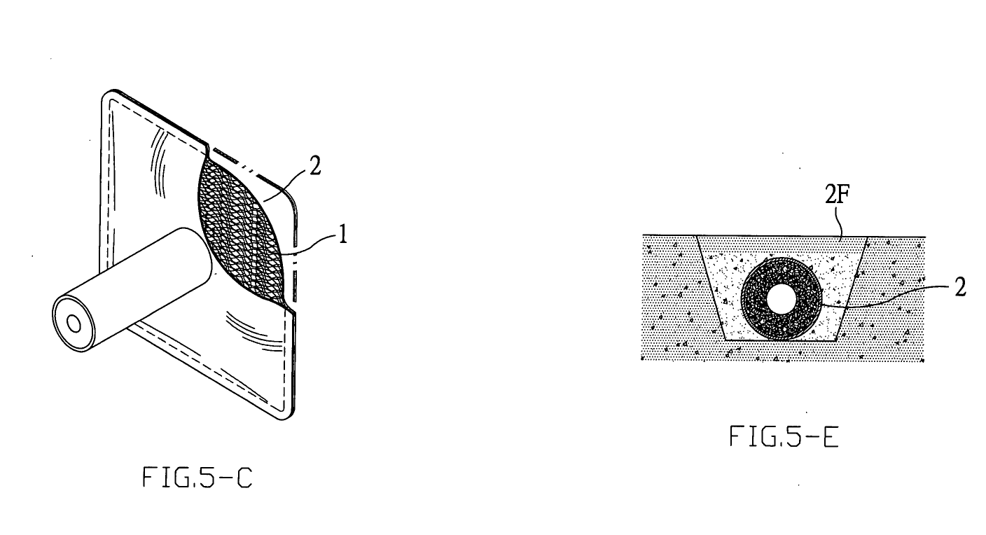

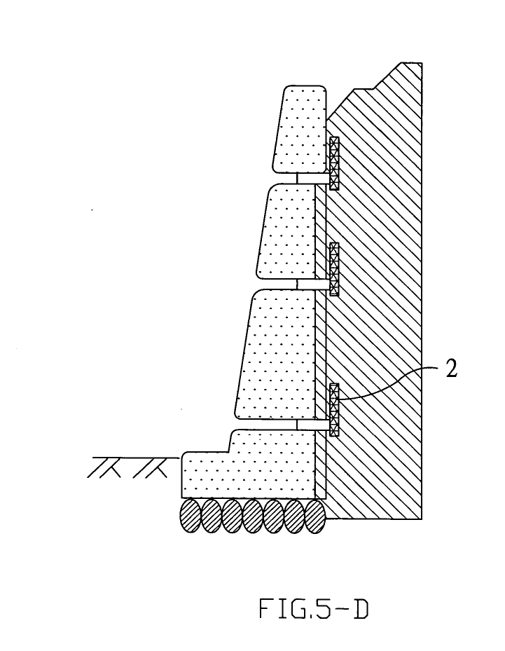

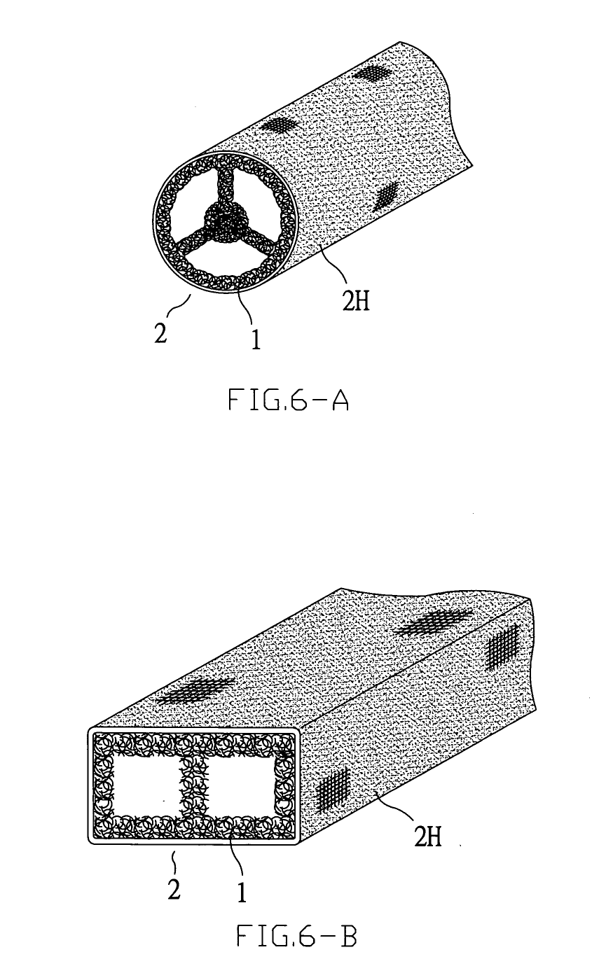

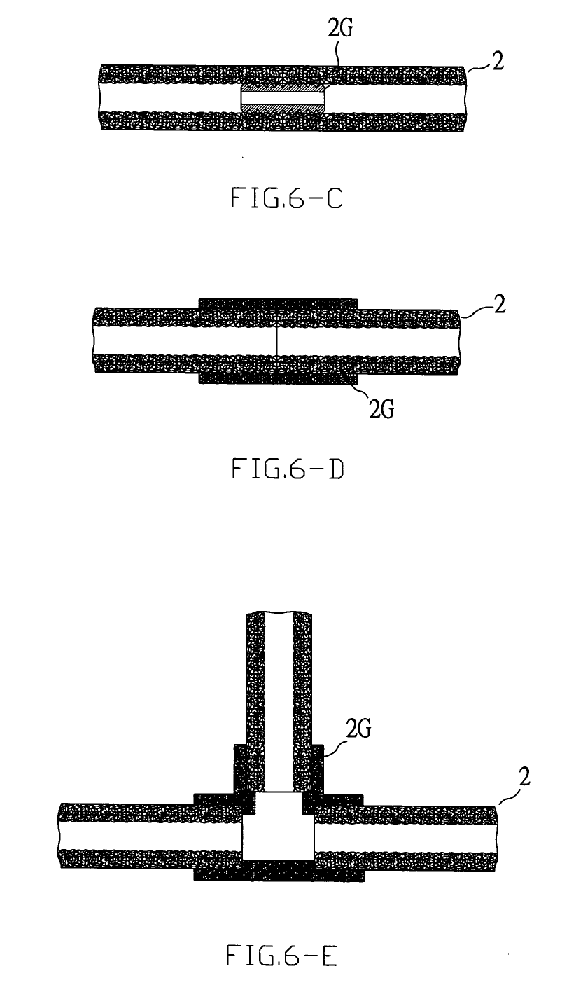

3. When the plastic material entity 2 of the invention herein has a hard structure, it can be fabricated as a material capable of withstanding high pressure and, furthermore, having a large opening ratio and optimal permeability such that when buried in ground surfaces and sloped surfaces 2E; as for rain water and underground water, since the plastic material entity 2 of the invention herein is a material that withstands high pressure and has a large opening ratio along with optimal permeability, rain water and underground water are effectively discharged and mud is retained within the ground surfaces and sloped surfaces 2E, thereby effectively preventing mud erosion; in addition to water and soil maintenance, as indicated in FIG. 5-A, FIG. 5-B, FIG. 5-C, FIG. 5-D, and FIG. 5-E, since the present invention is suitable for specialized applications such as a fastening component 2G and a fiber filter material 2H in construction water discharging that improves upon the shortcomings of currently available building materials that are pressure-proof but non-permeable or permeable but not pressure-proof, it becomes a new type of construction material, as indicated in FIG. 6-A, FIG. 6-B, FIG. 6-C, FIG. 6-D, and FIG. 6-E.

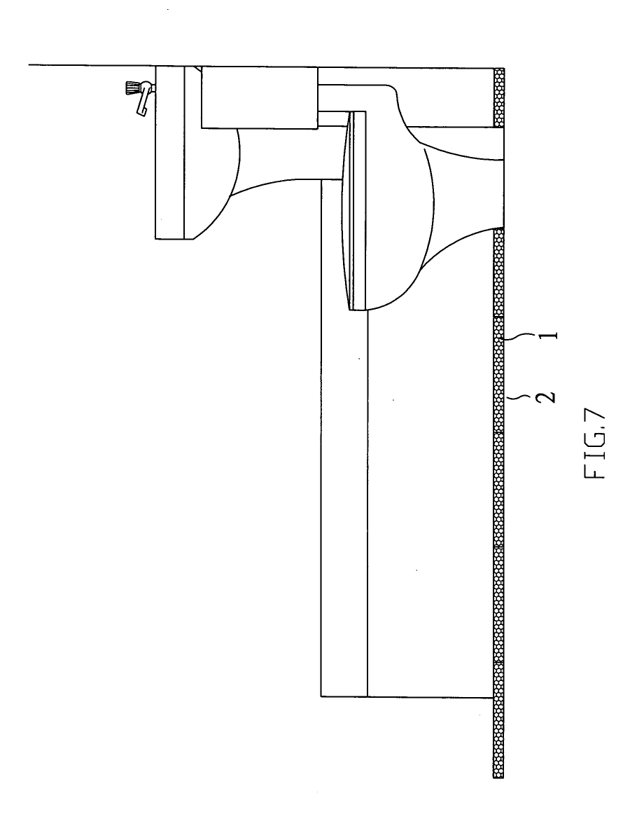

4. The plastic material entity 2 of the invention herein can be utilized to prevent slipping in bathrooms, as indicated in FIG. 7.

In addition, the firm plastic material entity 2 of the invention herein can be surrounded in a layer of non-woven cloth 2H or other substitute structure and, as such, similarly possess mud retaining capability on ground surfaces and sloped surfaces 2E to effectively guard against mud erosion and thereby effectively achieve the objective of water and soil maintenance.

The said most preferred embodiments cannot include every possible embodiment of the invention herein and, furthermore, can be fabricated in various forms of three-dimensional spatial arrangements (such as solid, planar, spiral, and other combined forms) and, moreover, after fabrication as required into different forms according to specific application, provide for free interchangeability and usage among applications; furthermore, the plastic material entity 2 structure of the invention herein is manufactured by a single production process and fabrication step which is quite convenient and raises overall economic benefit.

In summation of the foregoing section, since the structural content of the invention herein meets new patent application requirements, the present invention is submitted to the patent bureau for review and the granting of the commensurate patent rights.

1. A continuously spiraled, high porosity plastic material structure consisting of a soft, resilient plastic material that is heat melted and vertically flowed as continuous spirals utilizing a perforated mold and then tempered and cooled at low speed into shape to eliminate internal crystalline stress and thereby form long, thin strands of plastic filament having hardness and strength, the features of which are: After the long, thin said plastic filament is entwined and rolled in a continuous spiral utilizing an up and down vertically spiraled approach into a predetermined high porosity, three dimensionally shaped plastic material entity, the said plastic filament changes direction from an up and down vertically spiraled approach to a left and right horizontal approach, and both the top and bottom surfaces of the original, predetermined, and three-dimensionally shaped said plastic material entity are entwined and rolled in a continuous spiral such that the original, predetermined, and three-dimensionally shaped said plastic material entity becomes a level plane and thereby vertically and horizontally interlaced into a predetermined, high porosity, and three-dimensionally shaped said plastic material entity.

2. As mentioned in claim 1 of the continuously spiraled, high porosity plastic material structure of the invention herein, the said plastic material entity of a predetermined, high porosity, and three-dimensional shape has wave-like corrugations on its surface that are pressure formed by a mold.

3. As mentioned in claim 1 of the continuously spiraled, high porosity plastic material structure of the invention herein, the said plastic material entity of the invention herein can be surrounded in a layer of fiber filter material or other substitute structure and, as such, similarly possess mud retaining capability on ground surfaces and sloped surfaces to effectively guard against mud erosion and thereby effectively achieve the objective of water and soil maintenance.

4. As mentioned in claim 1 of the continuously spiraled, high porosity plastic material structure of the invention herein, when the said plastic material entity of the invention herein has a soft structure, it can be fabricated as a couch, bed, or seat cushion base material to replace commonly used cellular foam and coconut materials to improve damp heat and lack of ventilation characteristics, and also enhance infrared-resistant material into a healthier and cleaner ventilated material.

5. As mentioned in claim 1 of the continuously spiraled, high porosity plastic material structure of the invention herein, the said plastic material entity is capable of strengthening early plant growth and allowing accelerated flower and plant root growth and better drainage, while also capable of decomposition and environmental protection applications, enabling soil decomposing and absorption within short periods to achieve environmentally protective reclamation.

6. As mentioned in claim 1 of the continuously spiraled, high porosity plastic material structure of the invention herein, when the said plastic material entity of the invention herein has a hard structure, it can be fabricated as a material capable of withstanding high pressure and, furthermore, having a large opening ratio and optimal permeability such that when buried in ground surfaces and sloped surfaces; as for rain water and underground water, since the said plastic material entity of the invention herein is a material that withstands high pressure and has a large opening ratio along with optimal permeability, rain water and underground water are effectively discharged and mud is retained within the said ground surfaces and said sloped surfaces, thereby effectively preventing mud erosion and achieving the objective of water and soil maintenance.

7. As mentioned in claim 1 of the continuously spiraled, high porosity plastic material structure of the invention herein, the plastic material entity of the invention herein can be utilized as an anti-slip structure.
